(19) United States
(12) Patent Application Publication
(10) Pub. No.: US 2011/0229674 A1
(43) Pub. Date: Sep. 22, 2011

(54) POLYMERIZATION OF ALIPHATIC-AROMATIC COPOLYETHERESTERS

(75) Inventor: Mark F. Teasley, Landenberg, PA (US)

(73) Assignee: E.I. DuPont De Nemours and Company, Wilmington, DE (US)

(21) Appl. No.: 13/128,920

(22) PCT Filed: Dec. 14, 2009
(86) PCT No.: PCT/US09/67875

§ 371 Date: May 12, 2011

Related U.S. Application Data
(60) Provisional application No. 61/122,500, filed on Dec. 15, 2008.

(51) Int. Cl. C08G 63/672; C08G 63/688; C08L 67/02; C08L 3/02; C08G 63/80; C08G 63/85; B32B 1/02

(52) U.S. Cl. 428/36.92; 528/301; 528/295; 525/448; 524/47; 528/275; 528/279

(57) ABSTRACT

The polymerization processes described herein provide methods for controlling the dehydration of glycols such that dimers are formed as glycol ethers and incorporated into aliphatic-aromatic copolyetheresters during polycondensation. Control over this phenomenon provides unique polymer compositions with a range of thermo-mechanical properties, crystallinity, bio-content and biodegradability.

### FIELD OF THE INVENTION

The polymerization processes described herein provide methods for controlling the dehydration of glycols such that dimers are formed as glycol ethers and incorporated into aliphatic-aromatic copolyetheresters during polycondensation. Control over this phenomenon provides unique polymer compositions with a range of thermo-mechanical properties, crystallinity, bio-content and biodegradability.

### BACKGROUND

For numerous reasons, there is growing resistance to the use of petroleum as either a fuel or material feedstock. Instead, there is a trend towards increasing sustainability and reducing carbon footprint. Similarly, consideration of end of life scenario is gaining importance in product design. In the polymer world, these trends have manifested themselves in a search for monomers that are derived from a biological source and that impart biodegradability on the polymers into which they are incorporated.

Aliphatic-aromatic copolyesters are a general class of biodegradable polymers that can be prepared from such monomers, including for example, 1,3-propanediol, 1,4-butanediol, succinic acid, sebacic acid, azelaic acid, and brassylic acid, all of which can be derived from biological sources. The polyester repeat units derived from the aliphatic dicarboxylic acids enable enzymatic hydrolysis under biodegradation conditions, such as composting. More specifically, aliphatic-aromatic copolyetheresters can be prepared by incorporating poly(alkylene ether) glycols into these compositions to control other aspects of their physical properties. In addition, the poly(alkylene ether) glycol repeat units can enable a second mode of biodegradation occurring through their oxidative cleavage in the polymer chains.

Aliphatic-aromatic copolyetheresters described in the art generally include polyesters derived from a mixture of aliphatic dicarboxylic acids and aromatic dicarboxylic acids, which also incorporate poly(alkylene ether) glycols. Generally, known aliphatic-aromatic copolyetheresters incorporate high levels of the poly(alkylene ether) glycol component. For example, Warzelhan, et al., disclose aliphatic-aromatic copolyetherester compositions in U.S. Pat. Nos. 5,936,045, 6,046,248, 6,258,924, and 6,297,347 that have 20-25 mole percent of the poly(alkylene ether) glycol component and are found to have lowered crystalline melting point temperatures.

More recently, Hayes, in U.S. Pat. No. 7,144,632, discloses aliphatic-aromatic copolyetherester compositions that include 0.1 to about 3 mole percent of a poly(alkylene ether) glycol component with enhanced thermal properties and biodegradation rates. In contrast to the process described herein, the poly(alkylene ether) glycol is added as a separate monomer in each of the cases above. Also in contrast to the compositions described herein, the poly(alkylene ether) glycol is composed primarily of more than two alkylene ether repeat units and with a range of molecular weights.

There is a need to provide methods for controlling the dehydration of glycols such that dimers are formed as glycol ethers and incorporated into aliphatic-aromatic copolyetheresters during polycondensation, so that polymer compositions with a range of thermo-mechanical properties, crystallinity, bio-content and biodegradability, are provided.

### SUMMARY OF THE INVENTION

The present invention relates to an aliphatic-aromatic copolyetherester comprising:
a dicarboxylic acid component consisting essentially of:
   a. about 70 to 40 mole percent of an aromatic dicarboxylic acid component; and
   b. about 30 to 60 mole percent of an aliphatic dicarboxylic acid component based on 100 mole percent of total dicarboxylic acid component;
a glycol component consisting essentially of:
   a. about 99.9 to 98 mole percent of a single glycol component; and
   b. about 0.1 to 2 mole percent of a dialkylene glycol component based on 100 mole percent total glycol component; and
a sodium buffer component at about 0.001 to 0.1 weight percent sodium based on the total weight of the aliphatic-aromatic copolyetherester.
It further relates to the aliphatic-aromatic copolyetherester, obtainable by reacting a mixture comprising:
a dicarboxylic acid component consisting essentially of:
   a. about 70 to 40 mole percent of an aromatic dicarboxylic acid or ester-forming derivative thereof; and
   b. about 30 to 60 mole percent of an aliphatic dicarboxylic acid or ester-forming derivative thereof based on 100 mole percent of total dicarboxylic acid component;
a single glycol component; and
a sodium buffer component at about 0.001 to 0.1 weight percent sodium based on the total weight of the aliphatic-aromatic copolyetherester.

The invention further relates to a process to make an aliphatic-aromatic copolyetherester comprising:
a. combining one or more dicarboxylic acid monomers or diester derivatives thereof with a single glycol and an ester interchange catalyst to form a first reaction mixture;
b. heating the first reaction mixture with mixing to a temperature between about 200 degrees C. and about 260 degrees C., whereby volatile products of the ester interchange are distilled off, to form a second reaction mixture; and
c. polycondensing the second reaction mixture with stirring at a temperature between about 240 degrees C. and 260 degrees C. under vacuum to form the aliphatic-aromatic copolyetherester; wherein a sodium buffer compound is added at least once during any step in the process.

The invention further relates to blends of aliphatic-aromatic copolyetheresters with other polymeric materials, including natural substances. It also relates to shaped articles comprising aliphatic-aromatic copolyetheresters and their blends.

### DETAILS

Herein are described copolyetheresters and methods to achieve various properties normally imparted by aliphatic dicarboxylic acids on aliphatic-aromatic copolyesters by inclusion of dimers of some fraction of the constituent glycols. Furthermore, methods to produce, and to control the degree of production of these dimer glycol ethers during the polymerization process, are described. By these methods, a dimer glycol ether need not necessarily be charged to the reaction vessel but can instead be formed in situ from a charged glycol monomer to give the desired aliphatic-aromatic copolyetherester. This provides both a simplification and a cost savings to the process.

An illustration of the advantage provided by this approach is seen with regard to sebacic acid. Reaction of this monomer with terephthalic acid and 1,3-propanediol generates copolyesters that are useful for a number of applications. By a traditional approach, if one desired a certain set of thermal properties, the ratio of terephthalic acid and sebacic acid would be set to a specific value. Also in a traditional approach, using only these three monomers, no degree of freedom exists for the raw materials feed ratio if a specific set of thermal properties must be met. In contrast, by the approach described herein these thermal properties are achieved with a variety of raw materials feed ratios. In the limit of restricting dimerization of the 1,3-propanediol to 0, the feed rates would be the same as those for the traditional approach. When a small degree of dimerization is encouraged, then the 1,3-propanediol feed rate is increased slightly while the sebacic acid feed rate is decreased slightly. If a large degree of dimerization is encouraged, then the 1,3-propanediol feed rate is increased significantly while the sebacic acid feed rate is decreased significantly. In each case, with appropriate control, the copolymer has the desired target physical properties. In this specific example, the content of one monomer, sebacic acid, which is derived from a biological source is balanced against another, 1,3-propanediol, that is also from a biological source.

The polymerization processes described herein provide methods for controlling the dehydration of glycols such that dimers of the glycols are formed as glycol ethers and incorporated into aliphatic-aromatic copolyetheresters during polycondensation. Control over this phenomenon provides unique polymer compositions with a range of thermo-mechanical properties, crystallinity, bio-content and biodegradability. Generation of a wide range of properties allows development of polymers that can be used for a wide range of applications. Control over dimerization and the resulting impact on polymer composition and properties are illustrated by the examples below.

The copolyetheresters are typically semicrystalline. The term “semicrystalline” is intended to indicate that some fraction of the polymer chains of the aromatic-aliphatic copolyetheresters reside in a crystalline phase with the remaining fraction of the polymer chains residing in a non-ordered glassy amorphous phase. The crystalline phase is characterized by a melting temperature, Tm, and the amorphous phase by a glass transition temperature, Tg, which can be measured using Differential Scanning calorimetry (DSC).

Disclosed herein are aliphatic-aromatic copolyetheresters, which comprise a dicarboxylic acid component and a glycol component. Generally, the dicarboxylic acid component consists essentially of between about 70 and 40 mole percent of an aromatic dicarboxylic acid component based on 100 mole percent total acid component, and between about 30 and 60 mole percent of an aliphatic dicarboxylic acid component based on 100 mole percent of total dicarboxylic acid component. Additionally, the glycol component consists essentially between about 99.9 to 98 mole percent of a single glycol component based on 100 mole percent total glycol component, and between about 0.1 to 2 mole percent of a dialkylene glycol component based on 100 mole percent total glycol component.

In a typical embodiment of the aliphatic-aromatic copolyetherester, the dicarboxylic acid component consists essentially of between about 62 and 48 mole percent of an aromatic aromatic dicarboxylic acid component and between about 38 and 52 mole percent of an aliphatic dicarboxylic acid component based on 100 mole percent of total dicarboxylic acid component. More typically, the dicarboxylic acid component consists essentially of between about 56 and 50 mole percent of an aromatic dicarboxylic acid component and between about 44 and 50 mole percent of an aliphatic dicarboxylic acid component based on 100 mole percent of total dicarboxylic acid component.

In the disclosed embodiments, the glycol component typically consists essentially of between about 99.9 to 99 mole percent of a single glycol component and between about 0.1 and 1 mole percent of a dialkylene glycol component based on 100 mole percent total glycol component. More typically, the glycol component consists essentially of between about 99.8 and 99.3 mole percent of a single glycol component and between about 0.2 and 0.7 mole percent of a dialkylene glycol component based on 100 mole percent total glycol component.

Aromatic dicarboxylic acid components useful in the aliphatic-aromatic copolyetheresters include unsubstituted and substituted aromatic dicarboxylic acids, bis(glycolates) of aromatic dicarboxylic acids, and lower alkyl esters of aromatic dicarboxylic acids having from 8 carbons to 20 carbons. Examples of desirable dicarboxylic acid components include those derived from terephthalates, isophthalates, phthalates, naphthalates and bibenzoates. Specific examples of desirable aromatic dicarboxylic acid component include terephthalic acid, dimethyl terephthalate, bis(2-hydroxyethyl)terephthalate, bis(3-hydroxypropyl)terephthalate, bis(4-hydroxybutyl)terephthalate, isophthalic acid, dimethyl isophthalate, bis(2-hydroxyethyl)isophthalate, bis(3-hydroxypropyl)isophthalate, bis(4-hydroxybutyl)isophthalate, phthalic acid, phthalic anhydride, dimethyl phthalate, bis(2-hydroxyethyl)phthalate, bis(3-hydroxypropyl)phthalate, bis(4-hydroxybutyl)phthalate, 2,6-napthalenedicarboxylic acid, dimethyl 2,6-naphthalate, 2,7-naphthalenedicarboxylic acid, dimethyl 2,7-naphthalate, 3,4′-diphenyl ether dicarboxylic acid, dimethyl 3,4′-diphenyl ether dicarboxylate, 4,4′-diphenyl ether dicarboxylic acid, dimethyl 4,4′-diphenyl ether dicarboxylate, 3,4′-diphenyl sulfide dicarboxylic acid, dimethyl 3,4′-diphenyl sulfide dicarboxylate, 4,4′-diphenyl sulfide dicarboxylic acid, dimethyl 4,4′-diphenyl sulfide dicarboxylate, 3,4′-diphenyl sulfone dicarboxylic acid, dimethyl 3,4′-diphenyl sulfone dicarboxylate, 4,4′-diphenyl sulfone dicarboxylic acid, dimethyl 4,4′-diphenyl sulfone dicarboxylate, 3,4′-benzophenonedicarboxylic acid, dimethyl 3,4′-benzophenonedicarboxylate, 4,4′-benzophenonedicarboxylic acid, dimethyl 4,4′-benzophenonedicarboxylate, 1,4-naphthalenedicarboxylic acid, dimethyl 1,4-naphthalate, 4,4′-methylenebis(benzoic acid), dimethyl 4,4′-methylenebis(benzoate), and mixtures derived therefrom. Typically, the aromatic dicarboxylic acid component is derived from terephthalic acid, dimethyl terephthalate, bis(2-hydroxyethyl)terephthalate, bis(3-hydroxypropyl)terephthalate, bis(4-hydroxybutyl)terephthalate, isophthalic acid, dimethyl isophthalate, bis(2-hydroxyethyl)isophthalate, bis(3-hydroxypropyl)isophthalate, bis(4-hydroxybutyl)isophthalate, phthalic acid, phthalic anhydride, dimethyl phthalate, bis(2-hydroxyethyl)phthalate, bis(3-hydroxypropyl)phthalate, bis(4-hydroxybutyl)phthalate, and mixtures derived therefrom. More typically, the aromatic dicarboxylic acid component is derived from terephthalic acid and dimethyl terephthalate. However, essentially any aromatic dicarboxylic acid, ester, anhydride, or ester-forming derivative known can be used.

Aliphatic dicarboxylic acid components useful in the aliphatic-aromatic copolyetheresters include unsubstituted, substituted, linear, cyclic and branched, aliphatic dicarboxylic acids, bisglycolates of aliphatic dicarboxylic acids, and lower alkyl esters of aliphatic dicarboxylic acids having 2 to 36 carbon atoms. Specific examples of desirable aliphatic dicarboxylic acid components include, oxalic acid, dimethyl oxalate, malonic acid, dimethyl malonate, succinic acid, dimethyl succinate, methylsuccinc acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, dimethyl sebacate, bis(2-hydroxyethyl)sebacate, bis(3-hydroxypropyl)sebacate, bis(4-hydroxybutyl)sebacate, 1,11-undecanedicarboxylic acid (brassylic acid), 1,10-decanedicarboxylic acid, undecanedioic acid, 1,12-dodecanedicarboxylic acid, hexadecanedioic acid, docosanedioic acid, tetracosanedioic acid, dimer acid, 1,2-cyclohexanedicarboxylic acid, 1,2-cyclohexanedicarboxylic anhydride, 1,4-cyclohexanedicarboxylic acid, and mixtures derived therefrom. Typically, the aliphatic dicarboxylic acid component is derived from a renewable biological source, in particular succinic acid, azelaic acid, sebacic acid, and brassylic acid. However, essentially any aliphatic dicarboxylic acid, ester, anhydride, or ester-forming derivative known can be used.

The single glycol components that typically find use in the embodiments disclosed herein include aliphatic diols with 2 to 10 carbon atoms. The terms “glycol” and “diol” are used interchangeably to refer to general compositions of a primary, secondary, or tertiary alcohol containing two hydroxyl groups. Examples include 1,2-ethanediol, 1,3-propanediol, and 1,4-butanediol. Preferably, the glycol components are derived from a renewable biological source, in particular 1,3-propanediol and 1,4-butanediol. However, essentially any glycol known can be used including those containing aromatic, cycloaliphatic, branched, or heterogeneous structures.

The 1,3-propanediol used in the embodiments disclosed herein is preferably obtained biochemically from a renewable source (“biologically-derived” 1,3-propanediol). A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The polytrimethylene terephthalate based thereon utilizing the biologically-derived 1,3-propanediol, therefore, has less impact on the environment as the 1,3-propanediol used does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

The biologically-derived 1,3-propanediol, and polytrimethylene terephthalate based thereon, may be distinguished from similar compounds produced from a petrochemical source or from fossil fuel carbon by dual carbon-isotopic fingerprinting. This method usefully distinguishes chemically-identical materials, and apportions carbon material by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)ln(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. This latter half-life must not be taken literally; rather, one must use the detailed atmospheric nuclear input/decay function to trace the variation of atmospheric and biospheric ¹⁴C since the onset of the nuclear age. It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material), f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2042 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated ‰, and are calculated as follows:

$$δ {}^{13} C ≡ \frac{( {}^{13} C / {}^{12} C ) sample - ( {}^{13} C / {}^{12} C ) standard}{( {}^{13} C / {}^{12} C ) standard} \times 1000 {\%}_{o}$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making the polymers disclosed herein will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having a CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

As disclosed in the embodiments herein, aliphatic-aromatic copolyetheresters can be generated without addition of a dialkylene glycol as a reactant to the polymerization vessel. The desired physical properties of the copolyetheresters made in the present embodiments can be attained via control over glycol ether formation as demonstrated by a decrease in the melting temperature with an increase in the dialkylene glycol content for polymers with similar dicarboxylic acid contents. The added flexibility imparted by dimerization of the glycol can also be expected to alter other physical properties of the polymers. This control can be attained by monomer selection, catalyst selection, catalyst amount, choice of sulfonate group, addition of sodium buffer compounds and basic compounds, and other process conditions.

Sodium buffer compounds allow control over the glycol ether formation in a particularly useful way in that they can also serve to act as nucleating agents for aliphatic-aromatic copolyesters. Since excessive glycol ether formation can retard the crystallization rate for the resulting copolyetheresters, the sodium buffer compounds can thus affect crystallization in two different ways. Suitable sodium buffer compounds typically are non-corrosive sodium salts based on acids of low acidity that give compounds of low basicity with pH<9 including sodium salts of carboxylic acids and non-halide inorganic sodium salts. The acids are typically low in molecular weight such that they are sufficiently volatile to be removed during polymerization. Specific examples of desirable sodium buffer compounds are sodium acetate, sodium acetate trihydrate, sodium formate, sodium benzoate, monosodium terephthalate, and sodium bicarbonate.

The aliphatic-aromatic copolyetheresters disclosed herein can optionally contain a sulfonate component that consists essentially of sulfonate compounds or mixtures thereof. These sulfonate compounds can include compounds that incorporate as monomers into the backbone of the polymer chain and those that do not, such as dimethyl 5-sulfoisophthalate sodium salt, toluenesulfonic acid, or mixtures thereof. As a class, these compounds generally consist of those with strong acid moieties that promote the dimerization of glycols during the polymerization. In certain embodiments disclosed herein, the sulfonate component consists of dimethyl 5-sulfoisophthalate sodium salt. Generally, the sulfonate component is used in an amount of between about 0 and 5 mole percent based on the total moles of dicarboxylic acid component and glycol component incorporated into the aliphatic-aromatic copolyetherester. Typically, the sulfonate component is used in an amount of between about 0.5 and 2 mole percent.

Other compounds are added during the process to make the aliphatic-aromatic copolyetheresters disclosed herein. These compounds include basic compounds, such as tetramethylammonium hydroxide, sodium hydroxide, sodium carbonate, potassium hydroxide and potassium carbonate, which are added to limit the formation of glycol ether. Generally, as a class, these compounds are highly basic with pH>9. Such compounds limit the dimerization of glycols during the reaction.

Ester interchange catalysts are generally used in the processes disclosed herein. A number of catalysts can be used, including but not limited to titanium alkoxides, including titanium (IV) isoproproxide. The amount of ester interchange catalyst added can favor or disfavor the production of glycol ethers depending on other process conditions. More specifically, by adjusting the level of the ester interchange catalyst described here relative to the sodium buffer, basic, and sulfonate compounds described above, one can control the relative rates of the two reactions and thus the ultimate degree of dimerization that occurs.

A number of other process parameters can be used to control the degree of dimerization achieved during reaction. For example, reacting dimethyl esters of dicarboxylic acids rather than the dicarboxylic acids themselves with the glycol monomer reduces glycol ether formation. This is especially important when using sulfonated monomers because the combination of aromatic dicarboxylic acids and sulfonated compounds has been shown to dramatically increase the rate of dimerization. This combination has been found to lead to difficult control of the dimerization and high levels of glycol ether incorporation that can significantly impact the physical properties of the resulting copolyetheresters for some applications. Yet in some cases, this combination is desirable because higher levels of glycol ether incorporation can reduce the required level of the aliphatic dicarboxylic acid component needed to give the desired physical properties for the resulting aliphatic-aromatic copolyetheresters. Such compositions are preferable for certain applications, such as those requiring higher moisture uptakes, such as, for example, moisture-permeable waste disposal bags. In the embodiments disclosed herein, the combination of aromatic dicarboxylic acids and sulfonated compounds is avoided to provide control of the glycol ether incorporation over a lower, narrower range by using the sodium buffer compounds to give aliphatic-aromatic copolyetheresters suitable the applications disclosed herein. As another example of process parameters that control dimerization, the mole percent of glycol ether incorporated into the final polymer is increased when larger excesses of the glycol monomer are charged to the reaction vessel.

In general, the aliphatic-aromatic copolyetheresters can be polymerized from the disclosed monomers by any process known for the preparation of polyesters. Such processes can be operated in either a batch, semi-batch, or in a continuous mode using suitable reactor configurations. The specific batch reactor process used to prepare the polymers disclosed in the embodiments herein is equipped with a means for heating the reaction to 260° C. or higher, a fractionation column for distilling off volatile liquids, an efficient stirrer capable of stirring a high viscosity melt, a means for blanketing the reactor contents with nitrogen, and a vacuum system capable of achieving a vacuum of less than 1 Torr.

This batch process is generally carried out in two steps consisting of an ester interchange and polycondensation. In the first step, ester interchange, dicarboxylic acid monomers or their derivatives are combined with a single glycol in the presence of an ester interchange catalyst. The exact amount of monomers charged to the reactor is readily determined by a skilled practitioner depending on the amount of polymer desired and its composition. It is advantageous to use excess glycol in the ester interchange step, with the excess distilled off during the second, polycondensation step. A glycol excess of 10 to 100% was commonly used. Catalysts are generally known in the art, and preferred catalysts for this process are titanium alkoxides. The amount of catalyst used is typically 10 to 300 parts titanium per million parts polymer. The combined monomers are heated gradually with stirring to a temperature in the range of 200 to 250° C. This results in the formation of an alcohol and/or water as volatile products of the ester interchange, which can distill out of the reaction vessel without loss of the excess glycol, and glycolate adducts of the dicarboxylic acids. Depending on the reactor and the monomers used, the reactor may be heated directly to 250° C., or there may be a hold at a temperature in the range of 200 to 230° C. The ester interchange step was usually completed at a temperature ranging from 240 to 260° C. The completion of the interchange step was determined from the amount of the alcohol and/or water collected and by falling temperatures at the top of the fractionation column.

The second step, polycondensation, is carried out at 240 to 260° C. under vacuum to distill out the excess glycol. The vacuum is gradually applied to avoid bumping of the reactor contents. Stirring is continued under full vacuum (less than 1 Torr) until the desired melt viscosity is reached. A practitioner experienced with the reactor is able to determine if the polymer has reached the desired melt viscosity from the torque on the stirrer motor. Generally, polymers with suitable physical properties are obtained when the zero shear melt viscosity at 260° C. is greater than at least 1000 Poise. More typically, values above 2000 Poise are achieved. In some embodiments, values above 5000 Poise are desirable.

In the two-step batch process, the sodium buffer component consists essentially of the sodium buffer compounds or mixtures thereof that are added during any step in the process to control the glycol ether formation. Typically, the sodium buffer component consists essentially of a single sodium buffer compound that is added with the monomers during the ester interchange step to achieve the maximum benefit on control of the ether glycol formation. Alternatively, the sodium buffer compound can be added later in the process, such as after completion of the ester interchange step or shortly after removing some of the excess glycol during the polycondensation step, and still achieve a degree of control. In some instances, it may be desirable to add the same sodium buffer compound in both steps of the process to give the total amount of the sodium buffer component in the aliphatic-aromatic coplyetherester. In other instances, it may be advisable to use different compositions of the sodium buffer compounds in the separate steps, or even mixtures thereof, to take advantage of differences in their solubility and melting point. With each batch, semi-batch, or continuous process, the method and timing of addition, the amount, and the composition of the sodium buffer compounds included in the sodium buffer component of the aliphatic-aromatic copolyetheresters is dictated by the desired degree of control over the glycol ether formation and by the specific reactor configuration and conditions.

For the aliphatic-aromatic copolyetheresters and processes of the embodiments disclosed herein, the sodium buffer component is used to give between about 0.001 and 0.1 weight percent sodium incorporated into aliphatic-aromatic copolyetherester based on the total weight formed, typically between about 0.01 and 0.08 weight percent sodium, and more typically between about 0.02 and 0.06 weight percent sodium. This is typically expressed in terms of parts per million (ppm) on a weight-to-weight basis giving a range of between about 10 and 1000 ppm sodium, typically between about 100 and 800 ppm sodium, and more typically between about 200 and 600 ppm.

It is generally preferred that the aliphatic-aromatic copolyetheresters have sufficiently high molecular weights to provide suitable melt viscosity for processing into shaped articles, and useful levels of mechanical properties in said articles. Generally, weight average molecular weights (Mw) from about 20,000 g/mol to about 150,000 g/mol are useful. More typical are Mw from about 50,000 g/mol to about 130,000 g/mol. Most typical are Mw from about 80,000 g/mol to about 110,000 g/mol. In practical terms, molecular weights are often correlated to solution viscosities, such as intrinsic or inherent viscosity. While the exact correlation depends on the composition of a given copolymer, the molecular weights above generally correspond to intrinsic viscosity (IV) values from about 0.5 dL/g to about 2.0 dL/g. More typical are IV values from about 1.0 dL/g to about 1.8 dL/g. Most typical are IV values from about 1.3 dL/g to about 1.6 dL/g.

Although the copolyetheresters prepared by the processes disclosed herein reach satisfactory molecular weights, it can be expedient to use chain extenders to rapidly increase the said molecular weights and minimize their thermal history while reducing the temperature and contact time of the interchange and polycondensation steps. Suitable chain extenders include diisocyanates, polyisocyanates, dianhydrides, diepoxides, polyepoxides, bis-oxazolines, carbodiimides, and divinyl ethers, which can be added at the end of the polycondensation step, during processing on mechanical extrusion equipment, or during processing of the copolyetheresters into desired shaped articles. Specific examples of desirable chain extenders include hexamethylene diisocyanate, methylene bis(4-phenylisocyanate), and pyromellitic dianhydride. Such chain extenders are typically used at 0.1 to 2 weight percent with respect to the copolyetheresters.

The molecular weights of the aliphatic-aromatic copolyetheresters can also be increased by post-polymerization processes, such as solid-phase polymerization and vacuum extrusion, both of which allow the efficient removal of any volatiles generated by polycondensation at their respective scales of temperature and time. The benefit of these processes is that the composition of the copolyetheresters remains unperturbed by the processing conditions. In each process, the temperature and time that is needed to obtain the necessary increase in molecular weight due to polycondensation can be determined by taking samples or by monitoring the process outputs, such as the torque reading for the mechanical extruder.

Alternatively, the melt viscosity can be increased by incorporating a branching agent into the copolyetheresters during polymerization to introduce long-chain branches. Suitable branching agents include trifunctional and polyfunctional compounds containing carboxylic acid functions, hydroxy functions, or mixtures thereof. Specific examples of desirable branching agents include 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid (trimesic acid), 1,2,4,5-benzenetetracarboxylic acid (pyromellitic acid), 1,2,4,5-benzenetetracarboxylic dianhydride (pyromellitic dianhydride), 3,3′,4,4′-benzophenonetetracarboxylic dianhydride, 1,4,5,8-naphthalenetetracarboxylic dianhydride, 1,3,5-cyclohexanetricarboxylic acid, pentaerythritol, glycerol, 2-(hydroxymethyl)-1,3-propanediol, 1,1,1-tris(hydroxymethyl)propane, 2,2-bis(hydroxymethyl)propionic acid, and mixtures derived therefrom. Such branching agents are typically used at 0.01 to 0.5 mole percent with respect to the dicarboxylic acid component or the glycol component as dictated by the majority functional group of the branching agent.

Additionally, the thermal behavior of the copolyetheresters can be adjusted to an extent by incorporating nucleating agents during polymerization or processing of the copolyetheresters to accelerate their crystallization rates and provide a more uniform distribution of crystallites throughout the bulk of the polymer. In such manner, the processing of the copolyetheresters can be improved by maintaining a more uniform and consistent thermal quenching of the molten polymer potentially leading to improvement in the mechanical properties of the shaped articles. Particularly suitable nucleating agents include the sodium buffer compounds described above, sodium salts of higher molecular weights carboxylic acids, and polymeric ionomers partially or fully neutralized with sodium cations. If incorporated during polymerization, sodium buffer compounds are typically used and can be added with the monomers or later in the process, such as after completion of the interchange step and before or during the polycondensation step. If compounded into a finished copolyetherester, the higher molecular weight sodium salts and the polymeric ionomers are typically used and can be added during mechanical extrusion with sufficient mixing. Specific examples of desirable nucleating agents include the sodium buffer compounds, sodium stearate, sodium erucate, sodium montanate (Licomont® NaV 101, Clariant), Surlyn® sodium ionomers (ethylene-methacrylic acid sodium ionomers, DuPont™) and AClyn® 285 (low molecular weight ethylene-acrylic acid sodium ionomer, Honeywell International, Inc.). Such nucleating agents are typically used at levels that deliver 10 to 1000 part per million (ppm) sodium on a weight-to-weight basis with respect to the copolyetheresters.

The aliphatic-aromatic copolyetheresters can be blended with other polymeric materials. Such polymeric materials can be biodegradable or not biodegradable, and can be naturally derived, modified naturally derived or synthetic.

Examples of biodegradable polymeric materials suitable for blending with the aliphatic-aromatic copolyetheresters include poly(hydroxyalkanoates), polycarbonates, poly(caprolactone), aliphatic polyesters, aliphatic-aromatic copolyesters, aliphatic-aromatic copolyetheresters, aliphatic-aromatic copolyamideesters, sulfonated aliphatic-aromatic copolyesters, sulfonated aliphatic-aromatic copolyetheresters, sulfonated aliphatic-aromatic copolyamideesters, and copolymers and mixtures derived therefrom. Specific examples of blendable biodegradable materials include the Biomax® sulfonated aliphatic-aromatic copolyesters of the DuPont Company, the Eastar Bio® aliphatic-aromatic copolyesters of the Eastman Chemical Company, the Ecoflex® aliphatic-aromatic copolyesters of the BASF corporation, poly(1,4-butylene terephthalate-co-adipate, (50:50, molar), the EnPol® polyesters of the IRe Chemical Company, poly(1,4-butylene succinate), the Bionolle® polyesters of the Showa High Polymer Company, poly(ethylene succinate), poly(1,4-butylene adipate-co-succinate), poly(1,4-butylene adipate), poly(amide esters), the Bak® poly(amide esters) of the Bayer Company, poly(ethylene carbonate), poly(hydroxybutyrate), poly(hydroxyvalerate), poly(hydroxybutyrate-co-hydroxyvalerate), the Biopol® poly(hydroxyalkanoates) of the Monsanto Company, poly(lactide-co-glycolide-co-caprolactone), the Tone® poly(caprolactone) of the Union Carbide Company, the EcoPLA® poly(lactide) of the Cargill Dow Company and mixtures derived therefrom. Essentially any biodegradable material can be blended with the aliphatic-aromatic copolyetheresters.

Examples of nonbiodegradable polymeric materials suitable for blending with the aliphatic-aromatic copolyetheresters include polyethylene, high density polyethylene, low density polyethylene, linear low density polyethylene, ultralow density polyethylene, polyolefins, ply(ethylene-co-glycidylmethacrylate), poly(ethylene-co-methyl(meth) acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth) acrylic acid), metal salts of poly(ethylene-co-(meth)acrylic acid), poly((meth)acrylates), such as poly(methyl methacrylate), poly(ethyl methacrylate), poly(ethylene-co-carbon monoxide), poly(vinyl acetate), poly(ethylene-co-vinyl acetate), poly(vinyl alcohol), poly(ethylene-co-vinyl alcohol), polypropylene, polybutylene, polyesters, poly(ethylene terephthalate), poly(1,3-propyl terephthalate), poly(1,4-butylene terephthalate), poly(ethylene-co-1,4-cyclohexanedimethanol terephthalate), poly(vinyl chloride), poly(vinylidene chloride), polystyrene, syndiotactic polystyrene, poly(4-hydroxystyrene), novalacs, poly(cresols), polyamides, nylon, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, and copolymers thereof and mixtures derived therefrom.

Examples of natural polymeric materials suitable for blending with the aliphatic-aromatic copolyetheresters include starch, starch derivatives, modified starch, thermoplastic starch, cationic starch, anionic starch, starch esters, such as starch acetate, starch hydroxyethyl ether, alkyl starches, dextrins, amine starches, phosphate starches, dialdehyde starches, cellulose, cellulose derivatives, modified cellulose, cellulose esters, such as cellulose acetate, cellulose diacetate, cellulose propionate, cellulose butyrate, cellulose valerate, cellulose triacetate, cellulose tripropionate, cellulose tributyrate, and cellulose mixed esters, such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethylcellulose, and hydroxyethylpropylcellulose, polysaccharides, alginic acid, alginates, phycocolloids, agar, gum arabic, guar gum, acacia gum, carrageenan gum, furcellaran gum, ghatti gum, psyllium gum, quince gum, tamarind gum, locust bean gum, gum karaya, xanthan gum, gum tragacanth, proteins, prolamine, collagen and derivatives thereof such as gelatin and glue, casein, sunflower protein, egg protein, soybean protein, vegetable gelatins, gluten, and mixtures derived therefrom. Thermoplastic starch can be produced, for example, as disclosed within U.S. Pat. No. 5,362,777. Essentially any natural polymeric material known can be blended with the aliphatic-aromatic copolyetheresters depending on the process conditions and compatibilizers that may be needed to obtain the desired blend composition.

The aliphatic-aromatic copolyetheresters and blends formed therefrom can be used to make a wide variety of shaped articles. Shaped articles that can be made from the aliphatic-aromatic copolyetheresters include films, sheets, fibers, filaments, bags, melt blown containers, molded parts such as cutlery, coatings, polymeric melt extrusion coatings on substrates, polymeric solution coatings onto substrates, laminates, and bicomponent, multi-layer, and foamed varieties of such shaped articles. The aliphatic-aromatic copolyetheresters are useful in making any shaped article that can be made from a polymer. The aliphatic-aromatic copolyetheresters can be formed into such shaped articles using any known process therefore, including thermoplastic processes such as compression molding, thermoforming, extrusion, coextrusion, injection molding, blow molding, melt spinning, film casting, film blowing, lamination, foaming using gases or chemical foaming agents, or any suitable combination thereof to prepare the desired shaped article.

Shaped articles, particularly those that find use in packaging, including films, bags, containers, cups, and trays among others, are typically desired to be compostable. The current standards for compostable packaging and packaging materials are described in ASTM D6400-04 and EN 13432:2000. As the more stringent standard, EN 13432 is more pertinent for the qualification of new compostable packaging materials. To qualify as compostable, the packaging must disintegrate in 3 months under the conditions of an industrial composting facility and biodegrade to carbon dioxide at the level of 90% in 6 months without any negative impact due to toxicity on the composting process or on plant growth using the resulting compost. In this regard, the aliphatic-aromatic copolyetheresters disclosed herein can be said to be biodegradable when their shaped articles used as packaging materials, such as films, are shown to be compostable. In a typical embodiment of this invention, the shaped articles comprise films that are compostable at thicknesses of up to 20 microns, more typically up to 70 microns, in some embodiments up to 120 microns, and in yet other embodiments greater than 120 microns.

The aliphatic-aromatic copolyetheresters, their blends, and the shaped articles formed therefrom can include any known additive used in polyesters as a processing aid or for end-use properties. The additives are preferably nontoxic, biodegradable, and derived from renewable biological sources. Such additives include compatibilizers for the polymer blend components, antioxidants, thermal and UV stabilizers, flame retardants, plasticizers, flow enhancers, slip agents, rheology modifiers, lubricants, tougheners, pigments, antiblocking agents, inorganic and organic fillers, such as silica, clay, talc, chalk, titanium dioxide, carbon black, wood flour, keratin, chitin, refined feathers and reinforcing fibers, such as glass fibers and natural fibers like paper, jute and hemp.

### Test Methods

The intrinsic viscosity (IV) of the copolyetheresters was determined using a Viscotek Forced Flow Viscometer (FFV) Model Y-900. Samples were dissolved in 50/50 wt % trifluoroacetic acid/methylene chloride (TFA/CH₂Cl₂) at a 0.4% (wt/vol) concentration at 19° C. The intrinsic viscosity values reported by this method were equivalent to values determined using Goodyear Method R-103b “Determination of Intrinsic Viscosity in 50/50 [by weight] Trifluoroacetic Acid/Dichloromethane”. This method can be applied to any polyester (i.e. poly(ethylene terephthalate) (PET), poly(trimethylene terephthalate) (3GT), poly(butylene terephthalate (PBT), poly(ethylene naphthalate) (PEN)) which is completely soluble in the 50/50 wt % TFA/CH₂Cl₂ solvent mixture. A sample size of 0.1000 g polyester was typically used to prepare a 25 mL polymer solution. Complete dissolution of the polymer generally occurred within 8 hours at room temperature. Dissolution time was dependent on the molecular weight, crystallinity, chemical structure, and form (i.e. fiber, film, ground, and pellet) of the polyester.

The compositions of the polymers were determined by Nuclear Magnetic Resonance Spectroscopy, NMR. Several pellets or flakes for each sample were dissolved in trifluoroacetic acid-d₁ at room temperature (one can also heat the sample to 50° C. without seeing any structural changes in order to speed up dissolution). The solution was transferred into a 5 mm NMR tube and the spectrum was obtained at 30° C. on a Varian S 400 MHz Spectrometer. Mole-% composition of the sample was calculated from the integrations of appropriate areas of the spectrum. The mole percents calculated for the di-n-propylene glycol contents are on the basis of both the dicarboxylic acid component and the glycol component that make up the polymer. Since the copolyetheresters consist of equal parts dicarboxylic acid component and glycol component, these values would be doubled if it is desired to convert to a basis of the glycol component alone.

Differential Scanning calorimetry, DSC, was performed on a TA Instruments (New Castle, Del.) Model Number 2920 under a nitrogen atmosphere. Samples were heated from 20° C. to 270° C. at 20° C./min., held at 270° C. for 5 min., quenched in liquid N2, heated from −100° C. to 270° C. at 10° C./min. (Tg), held at 270° C. for 3 min., cooled to −100° C. at 10° C./min. (Tc), held at −100° C. for 2 minutes, and heated from −100° to 270° C. at 10 C/min. (Tc and Tm).

### EXAMPLES

1,3-Propanediol was obtained from DuPont/Tate & Lyle, Loudon, Tenn., USA. All other chemicals, reagents and materials, unless otherwise indicated, were obtained from Aldrich Chemical Company, Milwaukee, Wis., USA.

Abbreviations used in the examples and tables below are as follows: 3G (1,3-propanediol), TPA (terephthalic acid), DMT (dimethyl terephthalate), T (terephthalic acid), Seb (sebacic acid), SIPA (dimethyl 5-sulfoisophthalate, sodium salt), Glu (glutaric acid), TMA (trimellitic acid), TMAnh (trimellitic anhydride), P (phthalic acid), PAnh (phthalic anhydride), CAnh (1,2-cyclohexanedicarboxylic anhydride), DPG (di-n-propylene glycol), NaOAc (sodium acetate trihydrate; EM Science, Chemy Hill, N.J.), NaHCO₃ (sodium bicarbonate; EMD Chemicals, Gibbstown, N.J.), NaOBz (sodium benzoate), and NaO₂CH (sodium formate).

### Example 1

A 250 milliliter three-neck glass flask was charged with the following reaction mixture components to give a theoretical yield of 80 g finished polymer with the composition of 50:25.5:23.5:1.0 mole % 3G:T:Seb:SIPA: 1,3-propanediol (48.66 grams, 1.8 equivalents), dimethyl terephthalate (35.18 grams), dimethyl isophthalate-3-sodium sulfonate, (2.10 grams), sebacic acid, (33.77 grams), and sodium acetate trihydrate (0.143 grams, 300 ppm Na). The flask was equipped with a Vigreux distillation head with graduated collection cylinder and a stainless steel stirrer with vacuum-tight PTFE bearing, and purged with a stream of nitrogen. The flask was then charged with titanium(IV) isopropoxide (25 microliters, 50 ppm Ti) and deaerated with stirring by carefully cycling between vacuum (100 Torr) and nitrogen three times. The reaction mixture was heated to 160° C. with stirring under nitrogen then ramped to 230° C. over 2.7 hours to begin the distillation. When the distillation ceased at 230° C., the temperature was increased to 250° C. to resume the distillation. After 2 hours, 19 milliliters of distillate had been collected over the entire heating cycle. The collection cylinder was exchanged for a collection flask, which was cooled with dry ice, and the reaction mixture was placed under full vacuum (less than 0.1 Torr). The reaction mixture was stirred at 250° C. for 2.3 hours under full vacuum while reducing the stirring rate to accommodate the increase in melt viscosity. The vacuum was then released with nitrogen and the reaction mass allowed to cool to room temperature. An additional 23.62 grams of condensate had been collected in the flask and 68.96 grams of a solid polymer was recovered.

A sample was measured for Goodyear intrinsic viscosity with a value of 1.31 dL/g. Differential scanning calorimetry (DSC) showed a crystalline Tm of 123.0° C. (19.8 J/g) and a glass transition Tg of −23.3° C. ¹H NMR showed the polymer had a di-n-propylene glycol content of 0.32 mole %.

The procedure of Example 1 was used to prepare Examples 2-4 and Comparative Example (CE) 1 with minor variations in their respective run times (Table 1). These examples demonstrate that increasing the amount of the sodium buffer compounds tends to decrease the amount of di-n-propylene glycol repeat units in the sulfonated aliphatic-aromatic copolyetheresters.

TABLE 1

| | 3G | DMT | Seb | SIPA | | Buffer | Na | IV | Tm | DPG |
|---|---|---|---|---|---|---|---|---|---|---|
| Example | (g) | (g) | (g) | (g) | Sodium | (g) | (ppm) | (dL/g) | (° C.) | (mole %) |
| 1 | 48.66 | 35.18 | 33.77 | 2.10 | NaOAc | 0.143 | 300 | 1.31 | 123 | 0.32 |
| 2 | 40.55 | 35.18 | 33.77 | 2.10 | NaOAc | 0.0714 | 150 | 1.33 | 118 | 0.36 |
| 3 | 48.66 | 35.18 | 33.77 | 2.10 | NaOAc | 0.237 | 500 | 1.19 | 125 | 0.15 |
| 4 | 48.66 | 35.18 | 33.77 | 2.10 | NaHCO3 | 0.146 | 500 | 1.27 | 124 | 0.26 |
| CE1 | 48.66 | 35.18 | 33.77 | 2.10 | none | — | 0 | 1.12 | 121 | 0.62 |

### Example 5

A 250 milliliter three-neck glass flask was charged with the following reaction mixture components to give a theoretical yield of 80 g finished polymer with the composition of 50:24.5:25.5 mole % 3G:T:Seb: 1,3-propanediol (48.66 grams, 1.8 equivalents), dimethyl terephthalate (33.80 grams), sebacic acid, (36.64 grams), and sodium acetate trihydrate (0.0714 grams, 150 ppm Na). The flask was equipped with a Vigreux distillation head with graduated collection cylinder and a stainless steel stirrer with vacuum-tight PTFE bearing, and purged with a stream of nitrogen. The reaction flask was then charged with titanium(IV) isopropoxide (25 microliters, 50 ppm Ti) and deaerated with stirring by carefully cycling between vacuum (100 Torr) and nitrogen three times. The reaction mixture was heated to 160° C. with stirring under nitrogen then ramped to 230° C. over 2.4 hours to begin the distillation. When the distillation ceased at 230° C., the temperature was increased to 250° C. to resume the distillation. After 2 hours, 18.5 milliliters of distillate had been collected over the entire heating cycle. The collection cylinder was exchanged for a collection flask, which was cooled with dry ice, and the reaction mixture was placed under full vacuum (less than 0.1 Torr). The reaction mixture was stirred at 250° C. for 3.3 hours under full vacuum while reducing the stirring rate to accommodate the increase in melt viscosity. The vacuum was then released with nitrogen and the reaction mass allowed to cool to room temperature. An additional 24.74 grams of condensate had been collected in the flask and 71.95 grams of a solid polymer was recovered.

A sample was measured for Goodyear intrinsic viscosity with a value of 1.86 dL/g. Differential scanning calorimetry (DSC) showed a crystalline Tm of 119° C. (23.4 J/g) and a glass transition Tg of −31.2° C. ¹H NMR showed the polymer had a di-n-propylene glycol content of 0.15 mole %.

The procedure of Example 5 was used to prepare Examples 6-9 and Comparative Examples 2-3 with minor variations in their respective run times (Table 2). These examples demonstrate that the amount of di-n-propylene glycol repeat units is decreased with an increase in the amount of sodium acetate for these aliphatic-aromatic copolyetheresters, especially when using glutaric acid as the aliphatic dicarboxylic acid, and is decreased when compared to the sulfonated aliphatic-aromatic copolyetheresters of Table 1.

TABLE 2

| | 3G | DMT | Seb | Glu | | Buffer | Na | IV | Tm | DPG |
|---|---|---|---|---|---|---|---|---|---|---|
| Example | (g) | (g) | (g) | (g) | Sodium | (g) | (ppm) | (dL/g) | (° C.) | (mole %) |
| 5 | 48.66 | 33.80 | 36.64 | — | NaOAc | 0.0714 | 150 | 1.86 | 119 | 0.15 |
| 6 | 48.66 | 33.80 | 36.64 | — | NaOAc | 0.143 | 300 | 1.36 | 123 | 0.12 |
| 7 | 48.79 | 33.89 | 36.74 | — | NaOAc | 0.237 | 500 | 1.82 | 120 | 0.08 |
| 8 | 48.79 | 33.89 | 36.74 | — | NaOAc | 0.0355 | 75 | 1.23 | 121 | 0.11 |
| CE2 | 48.79 | 33.89 | 36.74 | — | none | — | 0 | 1.28 | 120 | 0.15 |
| 9 | 58.13 | 39.56 | — | 29.15 | NaOAc | 0.237 | 500 | | 131 | 0.20 |
| CE3 | 58.13 | 39.56 | — | 29.15 | none | — | 0 | 1.45 | 112 | 5.44 |

### Example 10

A 250 milliliter three-neck glass flask was charged with the following reaction mixture components to give a theoretical yield of 100 g finished polymer with the composition of 50:26.45:23.5:0.05 mole % 3G:T:Seb:TMA: 1,3-propanediol (61.37 grams, 1.8 equivalents), terephthalic acid (39.37 grams), sebacic acid, (42.59 grams), trimellitic anhydride (0.0861 g) and sodium acetate trihydrate (0.178 grams, 300 ppm Na). The flask was equipped with a Vigreux distillation head with graduated collection cylinder and a stainless steel stirrer with vacuum-tight PTFE bearing, and purged with a stream of nitrogen. The reaction flask was then charged with titanium(IV) isopropoxide (187.4 microliters, 300 ppm Ti) and deaerated with stirring at 10 rpm by carefully cycling between vacuum (100 Torr) and nitrogen three times. The reaction mixture was heated to 165° C. with stirring at 50 rpm under nitrogen then ramped immediately to 265° C. to begin the distillation. After 2 hours at 265° C., 15.8 milliliters of distillate had been collected over the entire heating cycle. The collection cylinder was exchanged for a collection flask, which was cooled with dry ice, and the reaction mixture was placed under a 2 Torr vacuum. The reaction mixture was stirred at 265° C. for 2.5 hours under vacuum while seven samples of the polymer were taken at 30 minute intervals to monitor the increase in intrinsic viscosity. The vacuum was then released with nitrogen and the reaction mass allowed to cool to room temperature. An additional 26.7 grams of condensate had been collected in the flask.

A sample was measured for Goodyear intrinsic viscosity with a value of 1.02 dL/g. Differential scanning calorimetry (DSC) showed a crystalline Tm of 133° C. (29.0 J/g) and a glass transition Tg of −31.3° C. ¹H NMR showed the polymer had a di-n-propylene glycol content of 0.48 mole %.

The branched aliphatic-aromatic copolyetherester prepared in Example 10 was found to have a lower level of di-n-propylene glycol repeat units compared to Comparative Example 4 containing no sodium acetate (Table 3). Table 3 also shows Example 11 and Comparative Example 5 for polymerizations performed using less catalyst (100 ppm Ti) according to the procedure of Example 10 with minor variations in their respective run times. When compared to the results in Table 2, these examples show that using TPA gives higher levels of di-n-propylene glycol repeat units than DMT and that using less catalyst leads to a higher level of di-n-propylene glycol repeat units.

TABLE 3

| | 3G | TPA | Seb | TMAnh | | Buffer | Na | IV | Tm | DPG |
|---|---|---|---|---|---|---|---|---|---|---|
| Example | (g) | (g) | (g) | (g) | Sodium | (g) | (ppm) | (dL/g) | (° C.) | (mole %) |
| 10 | 61.37 | 39.37 | 42.59 | 0.09 | NaOAc | 0.178 | 300 | 1.02 | 133 | 0.48 |
| CE4 | 61.37 | 39.37 | 42.59 | 0.09 | none | — | 0 | 1.08 | 129 | 0.63 |
| 11 | 61.37 | 39.37 | 42.59 | 0.09 | NaOAc | 0.178 | 300 | 1.00 | 132 | 0.52 |
| CE5 | 61.37 | 39.37 | 42.59 | 0.09 | none | — | 0 | 1.11 | 133 | 0.74 |

### Example 12

A 250 milliliter three-neck glass flask was charged with the following reaction mixture components to give a theoretical yield of 100 g finished polymer with the composition of 50:26.45:23.5:0.05 mole % 3G:T:Seb:TMA: 1,3-propanediol (61.37 grams, 1.8 equivalents), dimethyl terephthalate (46.02 grams), sebacic acid, (42.59 grams), trimellitic anhydride (0.0861 g) and sodium acetate trihydrate (0.178 grams, 300 ppm Na). The flask was equipped with a Vigreux distillation head with graduated collection cylinder and a stainless steel stirrer with vacuum-tight PTFE bearing, and purged with a stream of nitrogen. The flask was then charged with titanium(IV) isopropoxide (62.5 microliters, 100 ppm Ti) and deaerated with stirring at 20 rpm by carefully cycling between vacuum (100 Torr) and nitrogen three times. The reaction mixture was heated to 165° C. with stirring at 50 rpm under nitrogen then ramped to 265° C. over 2 hour to begin the distillation. After 30 minutes at 265° C., 20.0 milliliters of distillate had been collected over the entire heating cycle. The collection cylinder was exchanged for a collection flask, which was cooled with dry ice, and the reaction mixture was placed under full vacuum (less than 0.1 Torr). The reaction mixture was stirred at 265° C. for 2 hours under full vacuum while 4 samples of the polymer were taken at 30 minute intervals to monitor the increase in intrinsic viscosity. The vacuum was then released with nitrogen and the reaction mass allowed to cool to room temperature. An additional 32.72 grams of condensate had been collected in the flask.

A sample was measured for Goodyear intrinsic viscosity for a value of 1.78 dL/g. Differential scanning calorimetry (DSC) showed a crystalline Tm of 130° C. (32.7 J/g) and a glass transition Tg of −28.8° C. ¹H NMR showed the polymer had a di-n-propylene glycol content of 0.20 mole %.

The procedure of Example 12 were repeated two more times in Examples 13 and 14 with minor variations in their respective run times to give polymers with di-n-propylene glycol contents of 0.15 and 0.17 mole as shown in Table 4 for an average of 0.17 mole %. The procedure of Example 12 was then repeated twice without the sodium acetate in Comparative Examples 6 and 7 to give copolyetheresters with higher di-n-propylene glycol contents that averaged to 0.25 mole %. When comparing the results of Table 4 with those of Table 3, it is apparent that DMT leads to lower levels of di-n-propylene glycol repeat units than TPA.

TABLE 4

| | 3G | DMT | Seb | TMAnh | | Buffer | Na | IV | Tm | DPG |
|---|---|---|---|---|---|---|---|---|---|---|
| Example | (g) | (g) | (g) | (g) | Sodium | (g) | (ppm) | (dL/g) | (° C.) | (mole %) |
| 12 | 61.37 | 46.02 | 42.59 | 0.09 | NaOAc | 0.178 | 300 | 1.78 | 130 | 0.20 |
| 13 | 61.37 | 46.02 | 42.59 | 0.09 | NaOAc | 0.178 | 300 | 1.60 | 132 | 0.15 |
| 14 | 61.37 | 46.02 | 42.59 | 0.09 | NaOAc | 0.178 | 300 | 1.48 | 135 | 0.17 |
| CE6 | 61.37 | 46.02 | 42.59 | 0.09 | none | — | 0 | 1.47 | 127 | 0.25 |
| CE7 | 61.37 | 46.02 | 42.59 | 0.09 | none | — | 0 | 1.36 | 127 | 0.25 |

### Example 15

A 250 milliliter three-neck glass flask was charged with the following reaction mixture components to give a theoretical yield of 80 g finished polymer with the composition of 50:26.5:23.5 mole % 3G:T:Seb: 1,3-propanediol (49.10 grams, 1.8 equivalents), terephthalic acid (31.56 grams), sebacic acid, (34.07 grams), and sodium benzoate (0.150 grams, 300 ppm Na). The flask was equipped with a Vigreux distillation head with graduated collection cylinder and a stainless steel stirrer with vacuum-tight PTFE bearing, and purged with a stream of nitrogen. The reaction flask was then charged with titanium(IV) isopropoxide (50 microliters, 100 ppm Ti) and deaerated with stirring at 20 rpm by carefully cycling between vacuum (100 Torr) and nitrogen three times. The reaction mixture was heated to 165° C. under nitrogen then ramped to 260° C. with stirring at 100 rpm to begin the distillation. After 2.7 hours at 260° C., 13.25 milliliters of distillate had been collected over the entire heating cycle. The collection cylinder was exchanged for a collection flask, which was cooled with dry ice, and the reaction mixture was placed under a 0.5 Torr vacuum. The reaction mixture was stirred at 260° C. for 2.5 hours under vacuum as the stirring rate was reduced to 10 rpm to accommodate the increase in melt viscosity. The vacuum was then released with nitrogen and samples of the polymer were taken for analysis. An additional 23.1 grams of condensate had been collected in the flask.

A sample was measured for Goodyear intrinsic viscosity with a value of 1.56 dL/g. Differential scanning calorimetry (DSC) showed a crystalline Tm of 130° C. (27.9 J/g) and a glass transition Tg of −28.0° C. ¹H NMR showed the polymer had a di-n-propylene glycol content of 0.25 mole %.

The aliphatic-aromatic copolyetherester prepared in Example 15 was found to have a lower level of di-n-propylene glycol repeat units compared to a polymerization with no sodium benzoate in Comparative Example 8 (Table 5). Table 5 also shows Examples 16 and 17, which demonstrate similar control of the di-n-propylene glycol repeat units by varying the amount and composition of the sodium buffer compound when using the procedure of Example 15 with minor variations in their respective run times.

TABLE 5

| | 3G | TPA | Seb | | Buffer | Na | IV | Tm | DPG |
|---|---|---|---|---|---|---|---|---|---|
| Example | (g) | (g) | (g) | Sodium | (g) | (ppm) | (dL/g) | (° C.) | (mole %) |
| 15 | 49.10 | 31.56 | 34.07 | NaOBz | 0.150 | 300 | 1.56 | 130 | 0.25 |
| 16 | 49.10 | 31.56 | 34.07 | NaOBz | 0.251 | 500 | 1.59 | 131 | 0.21 |
| 17 | 49.10 | 31.56 | 34.07 | NaOAc | 0.237 | 500 | 1.54 | 128 | 0.19 |
| CE8 | 49.10 | 31.56 | 34.07 | none | — | 0 | 1.57 | 131 | 0.33 |

### Example 18

A 250 milliliter three-neck glass flask was charged with the following reaction mixture components to give a theoretical yield of 100 g finished polymer with the composition of 50:25:20:5 mole % 3G:T:Seb:P: 1,3-propanediol (62.08 grams, 1.8 equivalents), terephthalic acid (37.65 grams), sebacic acid, (36.66 grams), and phthalic anhydride (6.71 g). The flask was equipped with a Vigreux distillation head with graduated collection cylinder and a stainless steel stirrer with vacuum-tight PTFE bearing, and purged with a stream of nitrogen. The reaction flask was then charged with titanium(IV) isopropoxide (62.5 microliters, 100 ppm Ti) and deaerated with stirring at 20 rpm by carefully cycling between vacuum (100 Torr) and nitrogen three times. The reaction mixture was heated to 165° C. under nitrogen then ramped to 250° C. with stirring at 100 rpm to begin the distillation. After 2.5 hours at 250° C., 15.0 milliliters of distillate had been collected over the entire heating cycle. The collection cylinder was exchanged for a collection flask, which was cooled with dry ice, and the reaction mixture was placed under full vacuum (less than 0.1 Torr). After the excess 1,3-propanediol was removed and a clear melt was obtained, the vacuum was released to nitrogen and sodium formate (0.089 grams, 300 ppm Na) was added to the molten polymer. The reaction mixture was then stirred at 250° C. for 3.4 hours under full vacuum as the stirring rate was reduced to 5 rpm to accommodate the increase in melt viscosity. The vacuum was then released with nitrogen and the reaction mass allowed to cool to room temperature. An additional 34.1 grams of condensate had been collected in the flask and 81.87 grams of a solid polymer was recovered.

A sample was measured for Goodyear intrinsic viscosity with a value of 1.76 dL/g. Differential scanning calorimetry (DSC) showed a crystalline Tm of 119° C. (18.3 J/g) and a glass transition Tg of −16.3° C. ¹H NMR showed the polymer had a di-n-propylene glycol content of 0.37 mole %.

The aliphatic-aromatic copolyetherester prepared in Example 18, which used phthalic anhydride as a comonomer, was found to have a lower level of di-n-propylene glycol repeat units compared to a polymerization with no sodium formate in Comparative Example 9 (Table 6). Table 6 also shows Example 19 and Comparative Example 10 to demonstrate the control of the di-n-propylene glycol repeat units with 1,2-cyclohexanedicarboxylic anhydride as comonomer using the procedure of Example 15 with minor variations in their respective run times.

TABLE 6

| | 3G | TPA | Seb | Comonomer | | | Buffer | Na | IV | Tm | DPG |
|---|---|---|---|---|---|---|---|---|---|---|---|
| Example | (g) | (g) | (g) | (g) | | Sodium | (g) | (ppm) | (dL/g) | (° C.) | (mole %) |
| 18 | 62.08 | 37.65 | 36.66 | PAnh | 6.71 | NaO2CH | 0.089 | 300 | 1.76 | 119 | 0.37 |
| CE9 | 62.08 | 37.65 | 36.66 | PAnh | 6.71 | none | — | 0 | 1.78 | 119 | 0.52 |
| 19 | 61.91 | 37.54 | 36.56 | CAnh | 6.97 | NaO2CH | 0.089 | 300 | 1.67 | 117 | 0.26 |
| CE10 | 61.91 | 37.54 | 36.56 | CAnh | 6.97 | none | — | 0 | 1.65 | 119 | 0.32 |

What is claimed is:

1. An aliphatic-aromatic copolyetherester comprising:
a dicarboxylic acid component consisting essentially of:
a. about 70 to 40 mole percent of an aromatic dicarboxylic acid component; and
b. about 30 to 60 mole percent of an aliphatic dicarboxylic acid component based on 100 mole percent of total acid component;
a glycol component consisting essentially of:
a. about 99.9 to 98 mole percent of a single glycol component; and
b. about 0.1 to 2 mole percent of a dialkylene glycol component based on 100 mole percent total glycol component; and.
a sodium buffer component at about 0.001 to 0.1 weight percent sodium based on the total weight of the aliphatic-aromatic copolyetherester.

2. The aliphatic-aromatic copolyetherester of claim 1 obtainable by reacting a mixture comprising:
a. about 70 to 40 mole percent of an aromatic dicarboxylic acid or ester-forming derivative thereof; and
b. about 30 to 60 mole percent of an aliphatic dicarboxylic acid or ester-forming derivative thereof based on 100 mole percent of total acid component;
a single glycol component; and
a sodium buffer component at about 0.001 to 0.1 weight percent sodium based on the total weight of the aliphatic-aromatic copolyetherester.

3. The aliphatic-aromatic copolyetherester of claim 1 wherein the aromatic dicarboxylic acid component is selected from the group consisting of terephthalic acid and dimethyl terephthalate.

4. The aliphatic-aromatic copolyetherester of claim 1 wherein the aliphatic dicarboxylic acid component is selected from the group consisting of succinic acid, azelaic acid, sebacic acid, and brassylic acid.

5. The aliphatic-aromatic copolyetherester of claim 1 wherein the single glycol component is selected from the group consisting of 1,3-propanediol and 1,4-butanediol.

6. The aliphatic-aromatic copolyetherester of claim 1 wherein the sodium buffer component is selected from the group consisting of sodium acetate, sodium acetate trihydrate, sodium formate, sodium benzoate, monosodium terephthalate, and sodium bicarbonate.

7. The aliphatic-aromatic copolyetherester of claim 1, optionally containing between 0 and about 5 mole percent of a sulfonate component.

8. The aliphatic-aromatic copolyetherester of claim 7, wherein the sulfonate component is dimethyl 5-sulfoisophthalate sodium salt.

9. The aliphatic-aromatic copolyetherester of claim 1 wherein:
the dicarboxylic acid component consists essentially of:
a. about 62 to 48 mole percent of an aromatic dicarboxylic acid component; and
b. about 38 to 52 mole percent of an aliphatic dicarboxylic acid component based on 100 mole percent of total acid component;
the glycol component consists essentially of:
a. about 99.9 to 99 mole percent of a single glycol component; and
b. about 0.1 to 1 mole percent of a dialkylene glycol component based on 100 mole percent total glycol component.

10. The aliphatic-aromatic copolyetherester of claim 1 wherein the sodium buffer component is at about 0.01 to 0.08 weight percent sodium based on the total weight of the aliphatic-aromatic copolyetherester.

11. A blend comprising the aliphatic-aromatic copolyetherester of claim 1 and at least one other polymeric material.

12. The blend of claim 11 wherein the other polymeric material is selected from the group consisting of a natural polymer, starch, and poly(lactic acid).

13. A shaped article comprising the aliphatic-aromatic copolyetherester of claim 1.

14. A shaped article of claim 13 selected from the group consisting of films, sheets, fibers, melt blown containers, molded parts, and foamed parts.

15. A process for making an aliphatic-aromatic copolyetherester comprising:
a. combining one or more dicarboxylic acid monomers or diester derivatives thereof with a single glycol in the presence of an ester interchange catalyst to form a first reaction mixture;
b. heating the first reaction mixture with mixing to a temperature between about 200 degrees C. and about 260 degrees C., whereby volatile products of ester interchange are distilled off, to form a second reaction mixture; and
c. polycondensing the second reaction mixture with stirring at a temperature between about 240 degrees C. and 260 degrees C. under vacuum to form the aliphatic-aromatic copolyetherester;
wherein a sodium buffer compound is added at least once during any step in the process.

16. The process of claim 15, wherein the single glycol is added in an excess of between about 10 and 100 mole percent relative to that needed to provide equimolar proportions of hydroxyl moieties and carboxylic acid moieties or ester-forming derivatives thereof to the reaction vessel.

17. The process of claim 15, wherein the ester interchange catalyst is a titanium alkoxide used in an amount of between about 10 to 300 parts titanium per million parts polymer.

18. The process of claim 15, wherein the sodium buffer compound is added in step (a) in the amount of between about 0.001 and 0.1 weight percent sodium based on the total weight of the aliphatic-aromatic copolyetherester.

19. The process of claim 15, wherein the sodium buffer compound is added in step (c) in the amount of between about 0.001 and 0.1 weight percent sodium based on the total weight of the aliphatic-aromatic copolyetherester.

20. The process of claim 15, wherein the aliphatic-aromatic copolyetherester has an intrinsic viscosity of between about 1.0 and 1.8 dL/g.
